(19) United States
(12) Patent Application Publication
(10) Pub. No.: US 2009/0278400 A1
(43) Pub. Date: Nov. 12, 2009

(54) TRUCK WHEEL CENTRAL COVER

(76) Inventor: Ming-Cheng WANG, Yung Kang City (TW)

Correspondence Address: Ming-Cheng WANG, P. O. BOX 90, Tainan City, 70499, TW

(21) Appl. No.: 12/119,487

(22) Filed: May 12, 2008

(51) Int. Cl. B60B 27/00

(52) U.S. Cl. 301/108.1

(57) ABSTRACT

A truck wheel central cover includes a main body provided with plural projecting holders spaced apart equidistantly and respectively formed inside with a recessed chamber disposed with an annular base at its lower side. Each annular base is cut with plural notches, and has its interior fixed with plural resisting members and its inner side formed with an engage edge. Plural coupling members are respectively received in the annular bases of the main body, respectively having a hexagonal accommodating chamber with an insert hole communicating with the outside and having projecting members respectively fixed at its inner end corners. Each coupling member is cut with plural notches, having its outer wall bored with an annular engage groove. By mutual engagement, the central cover can conveniently and quickly be assembled on a truck wheel rim.

### BACKGROUND OF THE INVENTION

1. Field of the Invention

This invention relates to a truck wheel central cover, particularly to one able to be conveniently, quickly and stably assembled on a wheel rim and having an integral structure.

2. Description of the Prior Art

Generally, a truck wheel has its center disposed thereon with a central cover for covering up the wheel axle and the fixing members (like bolts and nuts) of a truck wheel, as shown in FIG. 1. A conventional truck wheel central cover 1 is provided with a main body 10 having its central portion bored with a through hole 11 and its outer wall disposed with an annular groove 12. A cover 13 is covered on the through hole 11 of the main body 10 and has its circumferential wall formed with an engage edge 14 to be engaged in the annular groove 12 of the main body 10. The main body 10 further has its circumferential side bored with a plurality of through holes 15 spaced apart and respectively received therein with a cap cover 16 with a female threaded hole 17. In assembling, the cover 13 is first covered on the main body 10, and then the main body 10 is assembled on a truck wheel rim 18, as shown in FIGS. 2 and 3. Next, the bolts 19 on the wheel rim 18 are respectively inserted through the through holes 15 of the main body 10, and then the cap covers 16 are respectively screwed on the bolts 19 to let the cap covers 16 respectively fixed in the through holes 15 to firmly assemble the main body 10 on the wheel rim 18, thus finishing assembly of the central cover 1. However, when the conventional central cover 1 is assembled on the wheel rim 18, the cap covers 16 have to be respectively screwed on the bolts 19 of the wheel rim 18 one by one, requiring a lot of trouble. In addition, the cap covers 16 are likely to be loosened and fall off when the truck runs and vibrates.

### SUMMARY OF THE INVENTION

The objective of this invention is to offer a truck wheel central cover able to be conveniently, quickly and stably assembled on a wheel rim and having an integral structure.

The truck wheel central cover in the present invention includes a main body disposed thereon with at least one projecting holder having its interior formed with a recessed chamber provided with an annular base at its lower side. The annular base is cut with plural notches and has its interior fixed with plural resisting members and its inner circumference provided with an engage edge. A plurality of coupling members are respectively received in the annular bases of the main body, respectively having its interior formed with a hexagonal accommodating chamber having an insert hole communicating with the outside and having its inner end corners respectively fixed with a projecting member. Each coupling member has its circumferential wall cut with plural notches and its outer wall annularly bored with an engage groove. Plural nuts are respectively fitted in the hexagonal accommodating chambers of the coupling members, respectively having the outer wall bored with an annular engage groove.

### BRIEF DESCRIPTION OF DRAWINGS

This invention will be better understood by referring to the accompanying drawings, wherein;

FIG. 1 is an exploded perspective view of a conventional truck wheel central cover;

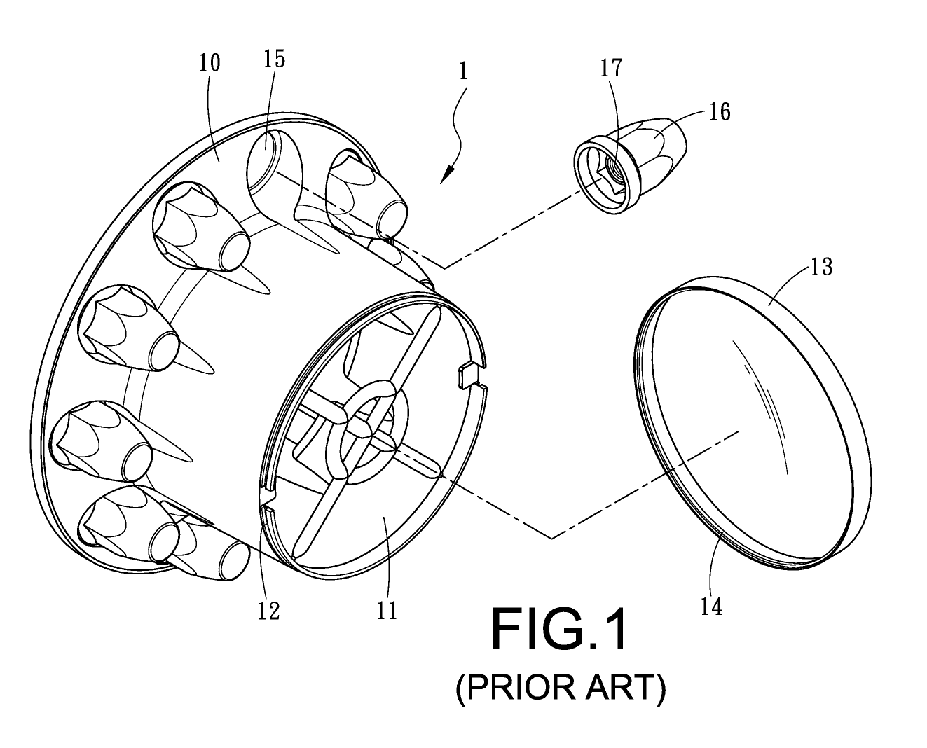

FIG. 2 is a cross-sectional view of the conventional truck wheel central cover;

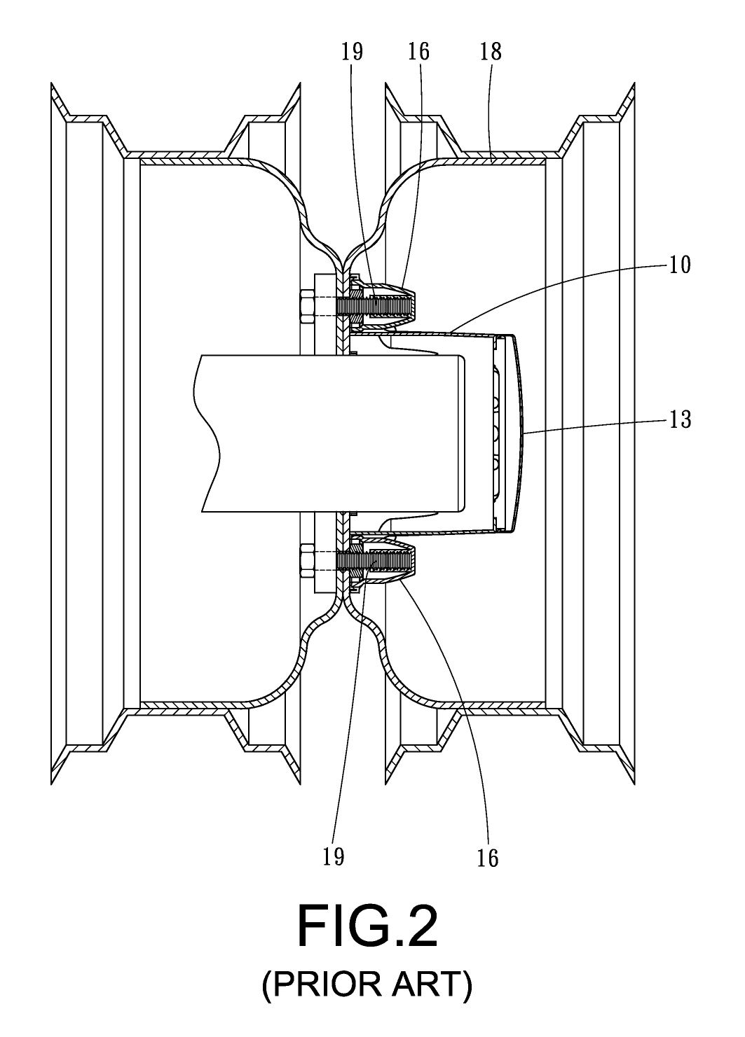

FIG. 3 is a partial magnified cross-sectional view of the conventional truck wheel central cover;

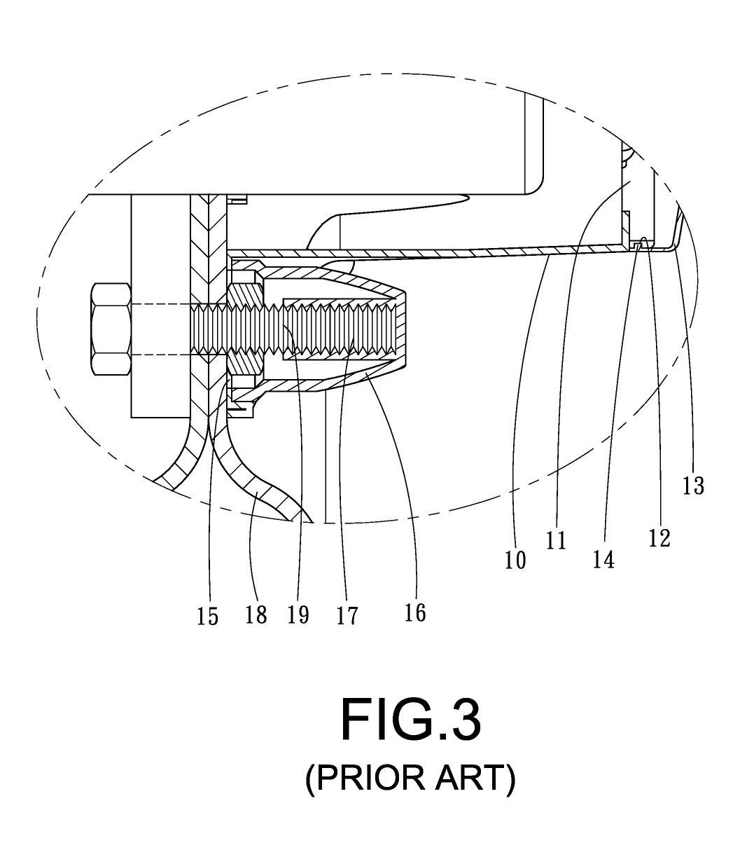

FIG. 4 is an exploded perspective view of a first preferred embodiment of a truck wheel central cover in the present invention;

FIG. 5 is partial magnified perspective view of the first preferred embodiment of the truck wheel central cover in the present invention;

FIG. 6 is a side cross-sectional view of the first preferred embodiment of the truck wheel central cover in the present invention;

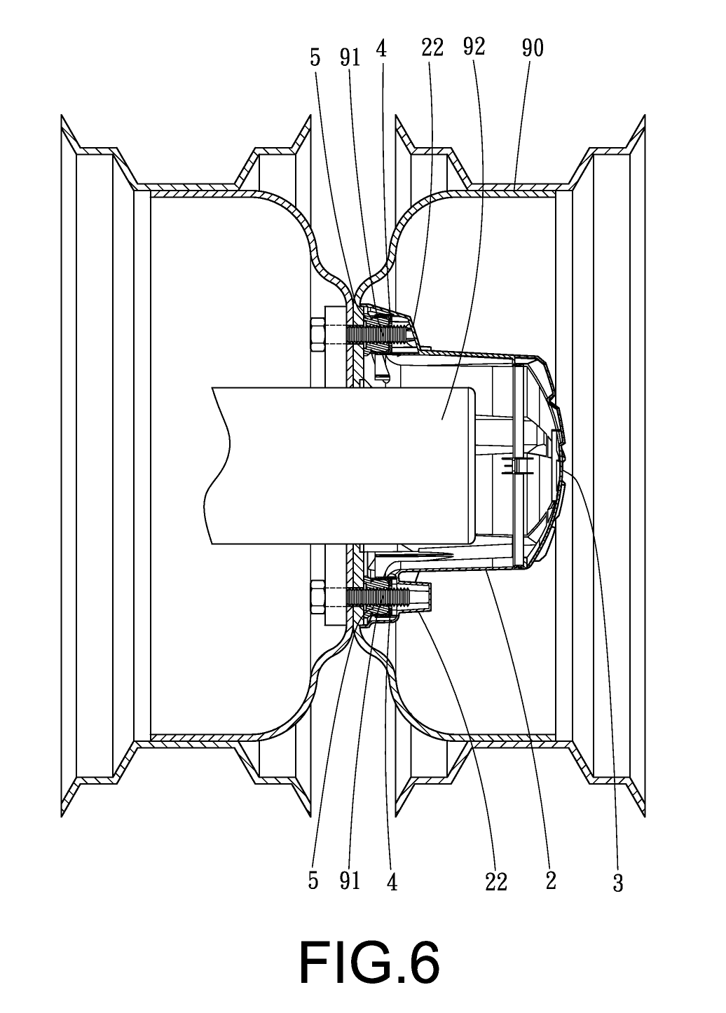

FIG. 7 is a partial magnified side cross-sectional view of the first preferred embodiment of the truck wheel central cover in the present invention;

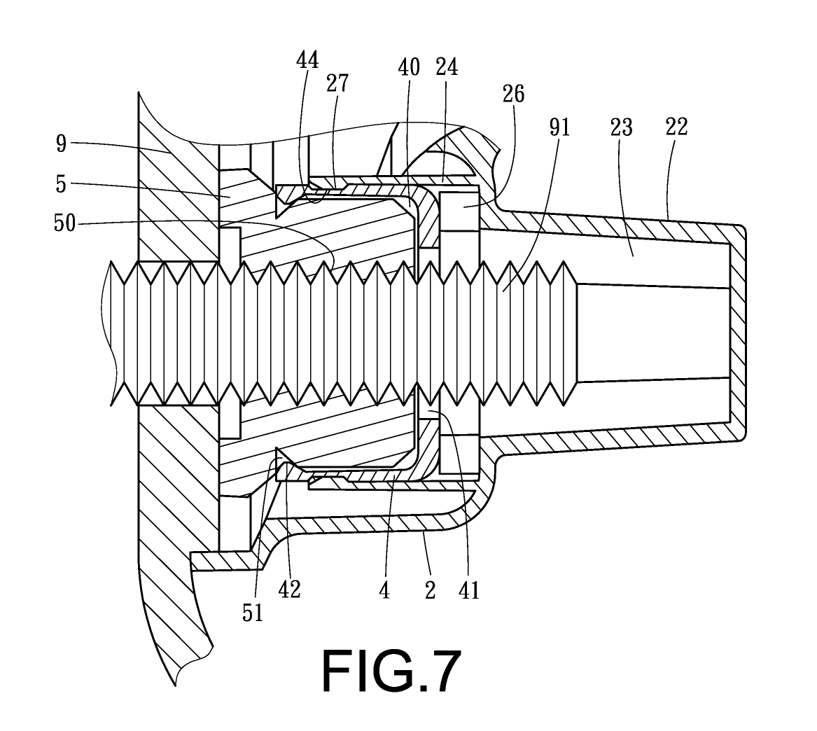

FIG. 8 is an exploded perspective view of a second preferred embodiment of a truck wheel central cover in the present invention;

FIG. 9 is a partial magnified perspective view of the second preferred embodiment of the truck wheel central cover in the present invention;

FIG. 10 is a side cross-sectional view of the second preferred embodiment of the truck wheel central cover in the present invention; and

FIG. 11 is a partial magnified side cross-sectional view of the second preferred embodiment of the truck wheel central cover in the present invention.

### DETAILED DESCRIPTION OF THE PREFERRED EMBODIMENT

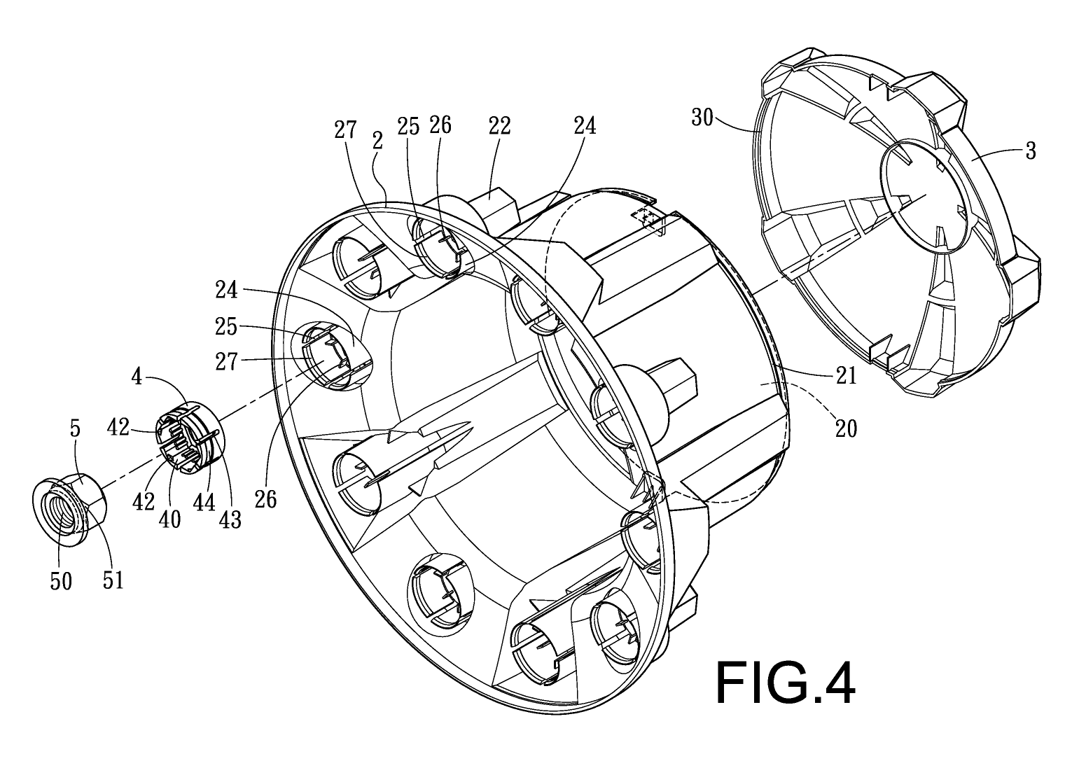

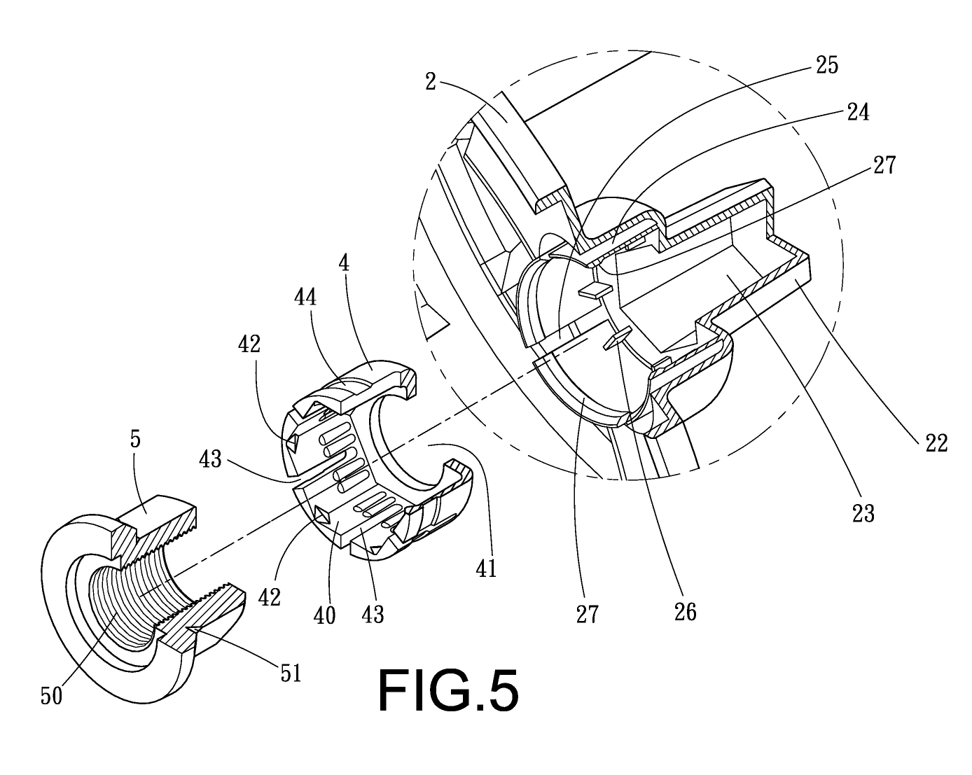

A first preferred embodiment of a truck wheel central cover in the present invention, as shown in FIGS. 4 and 5, includes a main body 2, a cover 3, a plurality of coupling members 4 and a plurality of nuts 5 as main components combined together.

The main body 2 has its central portion bored with a through hole 20 and its outer wall disposed with an annular groove 21. The main body 2 is further provided thereon with a plurality of projecting holders 22 space apart equidistantly and respectively having the interior formed with a recessed chamber 23 having an annular base 24 formed at its lower side. Each annular base 24 is cut with plural notches 25 and has its interior fixed with plural resisting members 26 and its inner edge annularly provided with an engage edge 27.

The covers 3 to be assembled on the through hole 20 of the main body 2 has its circumferential inner wall provided with an engage edge 30.

The coupling members 4 are respectively received in the interior of the annular bases 24 of the main body 2, respectively formed inside with a hexagonal accommodating chamber 40 having an insert hole 41 communicating with the outside. Each hexagonal accommodating chamber 40 has its inner end corners respectively fixed with a projecting member 42, and each coupling member 4 has its circumferential wall cut with plural notches 43 and its outer wall annularly bored with an engage groove 44.

The nuts 5 are respectively fitted in the hexagonal accommodating chambers 40 of the coupling members 4, respectively formed with a threaded hole 50 in the interior and having its outer wall annularly disposed with an engaged groove 51.

In assembling and using, referring to FIGS. 4˜7, firstly, the nuts 5 are respectively screwed with the bolts 91 on the wheel rim 90 of a truck rear wheel, and then the coupling members 4 are respectively fitted on the nuts 5, letting the nut 5 positioned in the hexagonal accommodating chamber 40 of the coupling member 4, and the projecting members 42 in the hexagonal accommodating chamber 40 engaged in the engage groove 51 of the nuts 5 to fix the coupling member 4 on the nut 5. Subsequently, the main body 2 is assembled on the outside of the wheel rim 90, and the coupling members 4 respectively fitted on the nuts 5 are respectively received in the annular bases 24 of the main body 2, letting the resisting members 26 in the annular base 24 resist against the coupling member 4 and the engage edge 27 engaged in the engage groove 44 in the outer wall of the coupling member 4. Thus, the coupling members 4 can be firmly connected with the main body 2, and at this time, the nut 5, the coupling member 4 and the bolt 91 are all received in the interior of the projecting base 22 of the main body 2, and the main body 2 can be stably fixed on the outside of the wheel rim 90 to cover up the wheel axle 92, the bolts 91 and the nut 5 of a truck. Lastly, the cover 3 is covered on the main body 2, letting the engage edge 30 of the cover 3 engaged in the annular groove 21 of the main body 2 to firmly assemble the cover 3 on the main body 2.

By so designing, this invention has the following advantages.

1. By engagement and connection of the coupling members 4, the central cover can conveniently, quickly and stably be assembled on the wheel rim 90 of a truck.

2. The main body 2 is formed integral with plural projecting holders 22 for covering up the bolts 91 and the nuts 5, having an integral structure.

3. The central cover of this invention can be assembled with less time than the conventional central cover that needs to assemble the cap covers 16 one by one, saving time and labor in assembly.

4. The assembly of the central cover is by mutual engagement and combination so all the members can be stably combined together and impossible to be loosened and fall off.

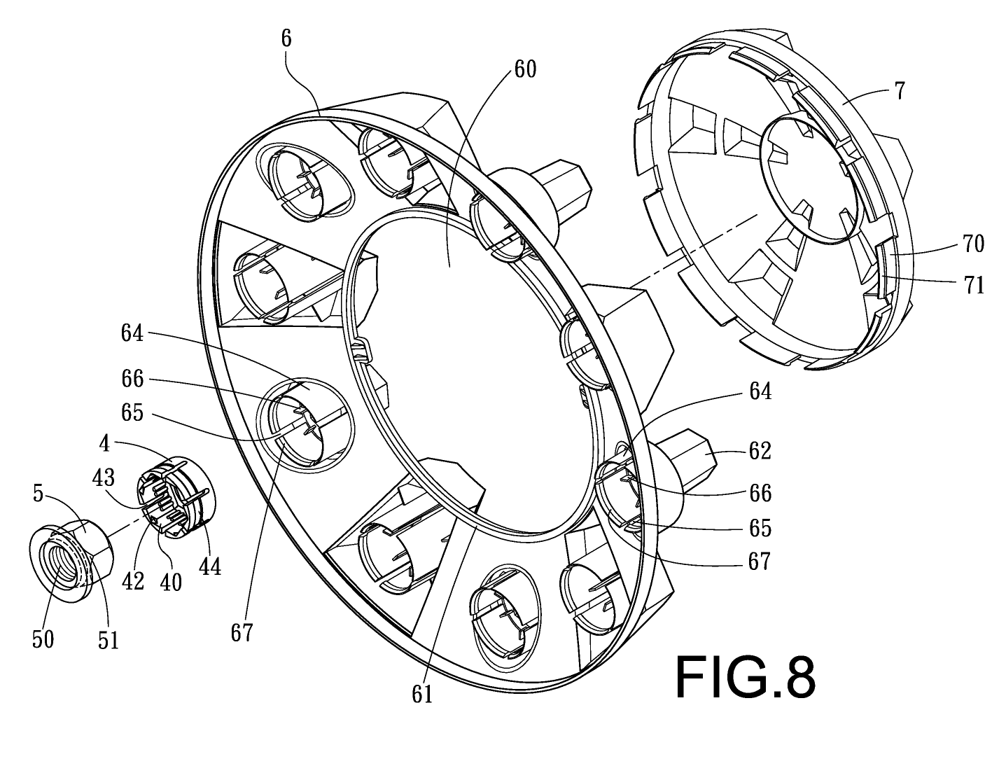

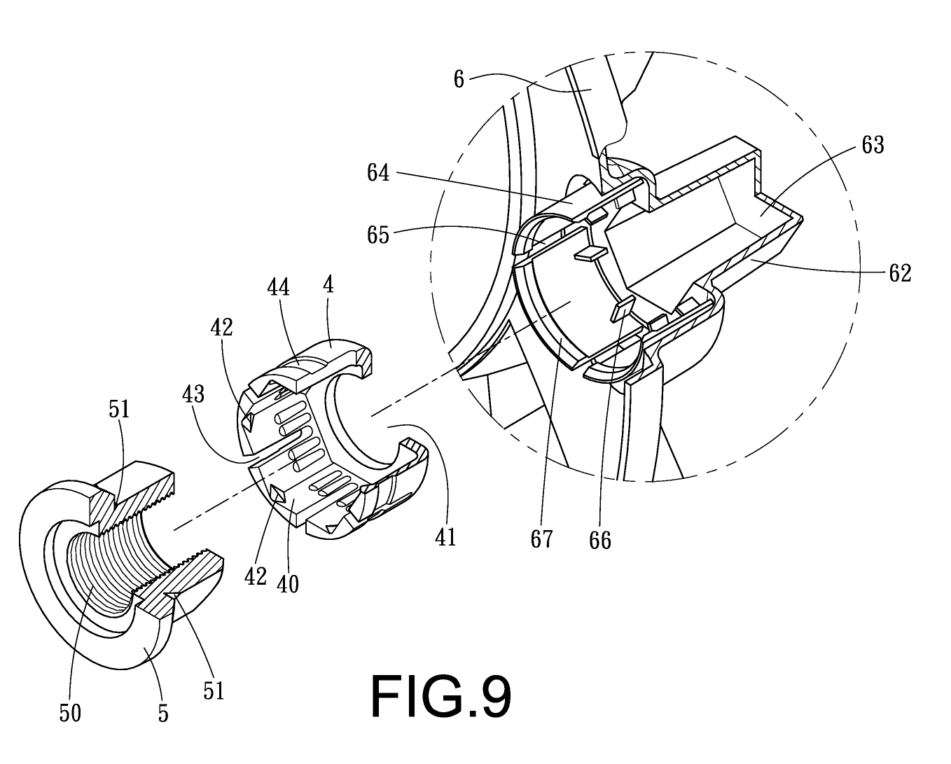

A second preferred embodiment of a truck wheel central cover in the present invention as shown in FIGS. 8 and 9, includes a main body 6 bored with a through hole 60 having its inner side disposed with a flange 61. The main body 6 is provided with a plurality of projecting holders 62 spaced apart equidistantly and respectively formed inside with a recessed chamber 63 disposed with an annular base 64 at the lower side. Each annular base 64 is cut with plural notches 65 and has its interior fixed with plural resisting members 66 and its inner edge annularly formed with an engage edge 67. A cover 7 to be covered on the through hole 60 of the main body 6 has its circumferential edge fixed thereon with plural positioning plates 70 respectively having the upper end provided with an engage edge 71. A plurality of coupling members 4 are respectively received in the interior of the annular bases 64 of the main body 6, respectively formed in the interior with a hexagonal accommodating chamber 40 with an insert hole communicating with the outside. Each hexagonal accommodating chamber 40 has its inner end corners respectively set with a projecting member 42, and each coupling member 4 has its circumferential wall cut with plural notches 43 and its outer wall annularly bored with an engage groove 44. A plurality of nuts 5 to be respectively fitted in the hexagonal accommodating chambers 40 of the coupling members 4 are respectively formed with a threaded hole 50 in the interior and respectively have the outer wall annularly bored with an engage groove 51.

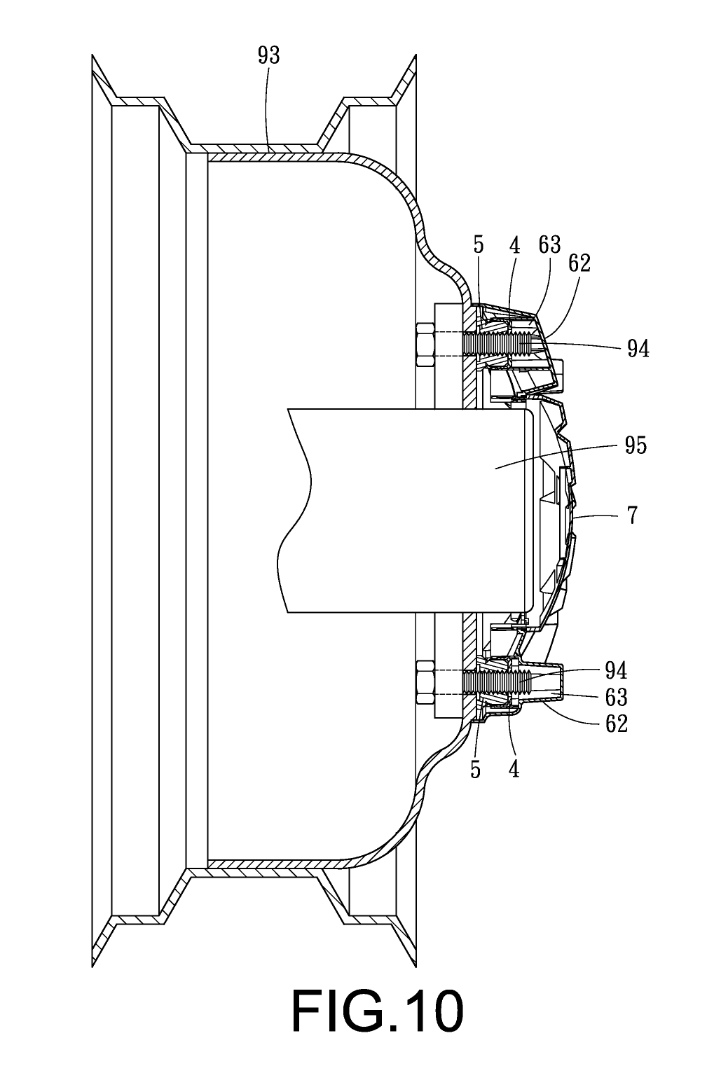

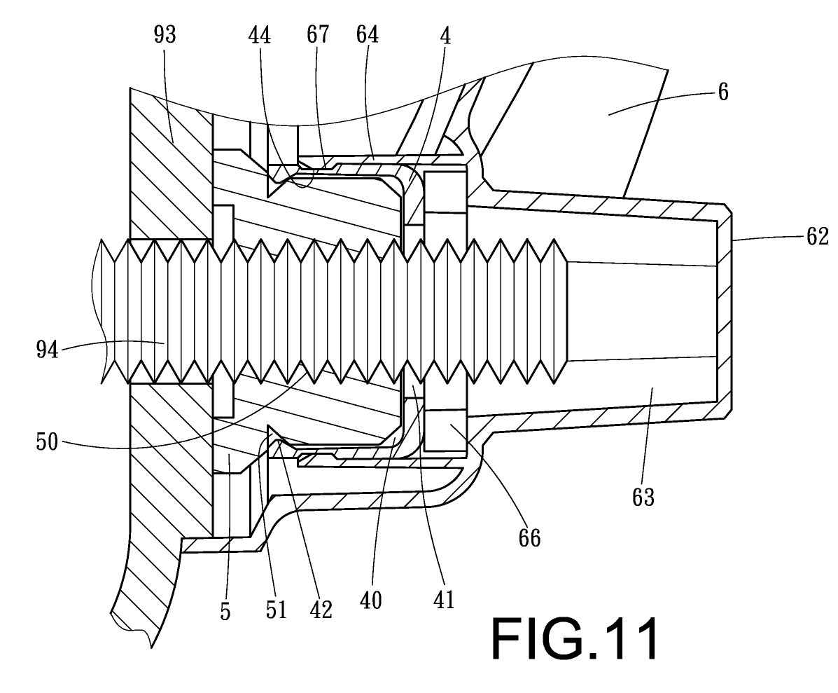

In assembling and using, referring to FIGS. 8 to 11, firstly, the nuts 5 are respectively screwed with the bolts 94 on the wheel rim 93 of a truck front wheel, and then the coupling members 4 are respectively fitted on the nuts 5, letting the nut 5 received in the hexagonal accommodating chamber 40, and the projecting members 42 in the hexagonal accommodating chamber 40 engaged in the engage groove 51 of the nut 5 to fix the coupling member 4 on the nut 5. Next, the main body 6 is assembled on the outside of the wheel rim 93, and the coupling members 4 respectively mounted on the nuts 5 are respectively positioned in the annular bases 64 of the main body 6, letting the resisting members 66 in the annular base 64 firmly hold on the coupling member 4 and the engage edge 67 engaged in the engage groove 44 in the outer wall of the coupling member 4 to connect the coupling member 4 with the main body 6 and fix them in position. Thus, the nut 5, the coupling member 4 and the bolt 94 are all received in the projecting holder 62 of the main body 6, and the main body 6 are firmly fixed on the outside of the wheel rim 93 to cover up the wheel axle 95, the bolt 94 and the nut 5 of a truck wheel. Subsequently, the cover 7 is covered on the main body 6, letting the positioning plates 70 of the cover 7 inserted in the through hole 60 of the main body 6 to have the engage edges 71 on the positioning plates 70 engaged with the flange 61 at the inner side of the through hole 60 of the main body 6 to fix the cover 7 on the main body 6.

Thus, by engaging and connecting the coupling members with the projecting holders 62 of the main body 6, the central cover can be convenient and quickly assembled on the truck wheel rim 93, and the main body 6 is formed integral with plural projecting holders 62 for covering up the bolts 94 and the nuts 5, having an integral structure. In addition, the assembly of the truck wheel central cover of this invention is to have the members combined together by mutual engagement; therefore, the members can be combined together with stability and impossible to be loosened and fall off.

While the preferred embodiments of the invention have been described above, it will be recognized and understood that various modifications may be made therein and the appended claims are intended to cover all such modifications that may fall within the spirit and scope of the invention.

What is claimed is:

1. A truck wheel central cover comprising a main body bored with a through hole, said main body having a cover covered thereon; and characterized by
said main body disposed thereon with at least one projecting holder formed with a recessed chamber in the interior, said recessed chamber having its lower side provided with an annular base, said annular base cut with plural notches and having plural resisting members fixed in the interior, said annular base having its inner side formed with an engage edge;
at least one coupling member respectively received in said annular bases of said main body, said coupling member formed with a hexagonal accommodating chamber in the interior, said hexagonal accommodating chamber having an insert hole communicating with its outside, said hexagonal accommodating chamber having its inner end corners respectively fixed with a projecting member, said coupling member cut with plural notches and having its outer wall annularly bored with an engage groove; and
at least one nut respectively fitted in said hexagonal accommodating chamber of said coupling member, said nut having its outer wall annularly bored with an engage groove.
